(19) United States
(12) Patent Application Publication
(10) Pub. No.: US 2009/0064242 A1
(43) Pub. Date: Mar. 5, 2009

(54) FAST CHANNEL SWITCHING FOR DIGITAL TV

(75) Inventors: Noam Cohen, Binyamina (IL); Gennady Rafalovich, Gan-Ner (IL); Arie Aig, Haifa (IL)

Correspondence Address: DARBY & DARBY P.C., P.O. BOX 770, Church Street Station, New York, NY, 10008-0770, US

(73) Assignee: Bitband Technologies Ltd., Netanya (IL)

(21) Appl. No.: 12/203,701

(22) Filed: Sep. 3, 2008

Related U.S. Application Data
(63) Continuation-in-part of application No. 11/321,290, filed on Dec. 22, 2005.
(60) Provisional application No. 60/638,534, filed on Dec. 23, 2004.

(51) Int. Cl. H04N 7/173

(52) U.S. Cl. 725/90; 725/118

(57) ABSTRACT

A method for digital video distribution in which a program is transmitted as a multicast stream over a network at a base rate. The stream includes a sequence of frames encoding video data, the sequence containing anchor points. A request from a client to begin receiving the program is received at a time subsequent to a given anchor point in the multicast stream. Responsively to the request, a boost stream is transmitted to the client beginning from the given anchor point at an accelerated rate relative to the base rate. The boost stream causes the client to display the video data beginning from the given anchor point and then to join the multicast stream when the boost stream has reached a point of synchronization with the multicast stream.

### CROSS-REFERENCE TO RELATED APPLICATION

This application is a continuation-in-part of U.S. patent application Ser. No. 11/321,290, filed Dec. 22, 2005, which claims the benefit of U.S. Provisional Patent Application 60/638,534, filed Dec. 23, 2004. The disclosures of both of these related applications are incorporated herein by reference.

### FIELD OF THE INVENTION

The present invention relates generally to multimedia multicasting over packet networks, and specifically to facilitation of channel switching by a client of such multicasting.

### BACKGROUND OF THE INVENTION

Streamed movies with video and audio, such as movies produced according to one of the Moving Picture Experts Group (MPEG) standards, comprise a number of types of frames:
Intracoded frames (I-frames), which are self-contained images, similar to JPEG-encoded still pictures (JPEG: Joint Photographic Experts Group).
Predictive frames (P-frames), which may incorporate differences from a prior frame.
Bi-directional frames (B-frames) which may incorporate differences from a prior and a subsequent frame.
   The sequence of I, P and B frames forms a byte stream, which is broken up into variable-length packets in a packetized elementary stream (PES). The PES packets may be packaged inside fixed-sized transport stream packets. Further information regarding these and other aspects of the MPEG standards, such as MPEG-2, may be found at www.chiariglione.org/mpeg/standards.htm.

U.S. Patent Application Publication 2004/0255328, whose disclosure is incorporated herein by reference, describes a technology for facilitating the presentation of digital video streams, and specifically for reducing the effective start-up delay in the presentation of the first frames of video content when a system tunes into a video stream. The delay is incurred because upon user selection of a video-stream channel, the receiver must wait for the next random access point (RAP), such as an I-frame, before it can access the video stream and start buffering and presenting the channel. To reduce the delay, a multicast system transmits to the user both a main multicast video stream and a number of lead-in alternative multicast video streams with staggered RAP phases. When the user selects a channel, the receiver queries the multicast server in order to determine which of the alternative streams is the first lead-in that has not yet started, and then joins that alternative stream. The alternative stream serves as a “bridge” until the receiver can start receiving the next RAP of the main stream.

PCT Patent Publications WO 2004/114667 and WO 2004/114668, whose disclosures are incorporated herein by reference, describe encoding and decoding methods and apparatus that are said to enable fast channel change of compressed video. The encoder includes a normal encoding portion for providing normal stream data and a lower-quality encoding portion for providing channel change stream data. A multiplexer combines the normal and channel change data streams. The decoder includes a demultiplexer, which separates the normal stream and the channel change stream.

### SUMMARY OF THE INVENTION

Embodiments of the present invention provide improved methods and systems for packetized streaming of digital media, which shorten the time between switching channels and displaying the new channel at a receiver. For this purpose, a service provider temporarily stores one or more recent frames from a multicast video stream in each of the channels for which fast switching is enabled. The stored frames go back to the most recent anchor point in the stream, meaning a point in the stream from which a decoder can begin to decode and display the streaming content. In the case of MPEG, the I-frames can serve as the anchor points.

When a user selects a new channel, the service provider immediately transmits a “boost stream” to the client. This boost stream begins from a recent anchor point, and may include other intermediate frames, as well, such as P-frames in an MPEG stream. The boost stream is typically transmitted at an accelerated bit rate relative to the base bit rate of the multicast stream. When the boost stream reaches a point of synchronization with the multicast stream, the client joins the multicast stream of the new channel.

Although the embodiments described herein refer specifically to MPEG standards and use MPEG terminology, the principles of the present invention may similarly be applied in digital broadcast systems using other compression and packet transport schemes. Therefore, in the context of the present patent application and in the claims, the term “intracoded frame” (or I-frame) should be understood as referring to any frame that can serve as an anchor point, while the term “difference-coded frame” should be understood as referring to any frame that is compressed by encoding differences from a preceding and/or succeeding frame.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a packetized video multicast system, in accordance with an embodiment of the present invention;

FIG. 2 is a block diagram that schematically illustrates a server operated by a service provider, in accordance with an embodiment of the present invention;

FIG. 3 is a flow chart that schematically illustrates a method for channel switching, in accordance with an embodiment of the present invention; and

FIG. 4 is a timing diagram that schematically illustrates construction and transmission of a boost stream, in accordance with an embodiment of the present invention.

### DETAILED DESCRIPTION OF EMBODIMENTS

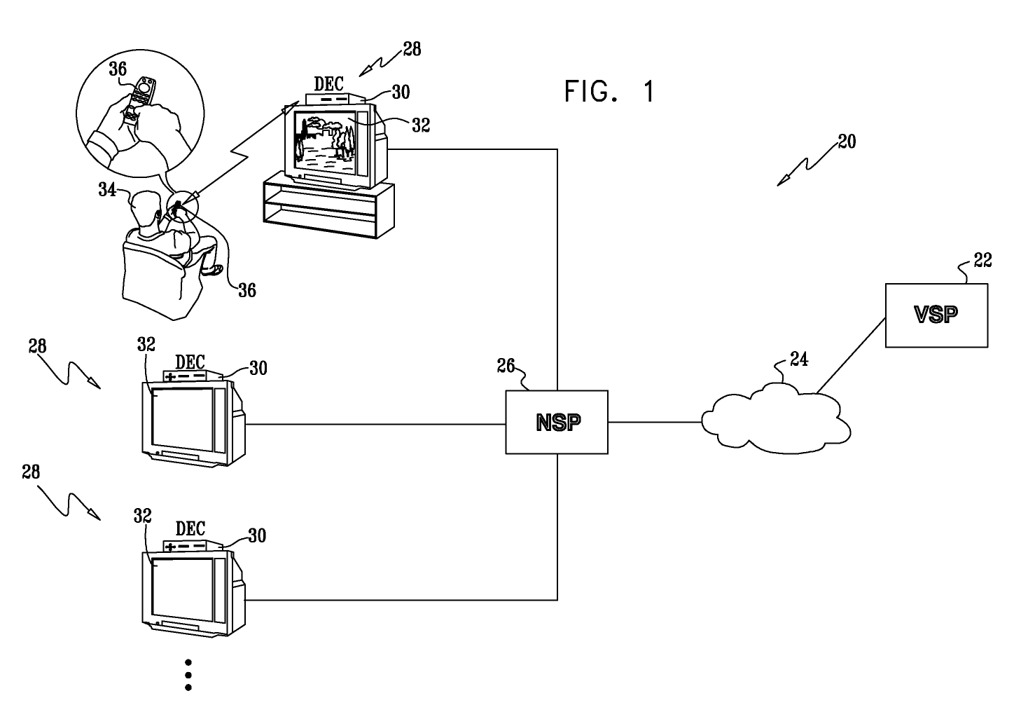

FIG. 1 is a block diagram that schematically illustrates a system 20 for packetized video multicast, in accordance with an embodiment of the present invention. A video service provider (VSP) 22 transmits a set of multicast video channels through a backbone packet network 24, such as the Internet. A network service provider (NSP) operates an access multiplexer 26, which serves as a multicast transmitter. Multiplexer 26 receives the multicast streams from VSP 22 and distributes the streams to client terminals 28 (which are also referred to herein simply as “clients”). Although only a single VSP is shown in FIG. 1, in practice the NSP may receive and distribute multicast streams from multiple different VSPs and may also serve itself as a VSP. In the pictured embodiment, each terminal 28 comprises a video decoder 30, such as a set-top box, which is connected to a television set 32. Alternatively, the terminals may comprise personal computers or any other type of suitable hardware known in the art.

A user 34 of client terminal 28 selects a channel for viewing using a controller 36, such as a remote control device. When the user enters a channel selection, decoder 30 sends a request to multiplexer 26 asking to “join” the selected channel. The multiplexer responds by transmitting the multicast stream of this channel to the decoder. When the user subsequently switches channels, the decoder sends a request to the multiplexer to “leave” the previous channel, followed by a request to join the new channel.

In order to reduce the time elapsed between the user's selection of the new channel and the display of new channel content on television set 32, decoder 30 may initially request a boost stream following the channel switch, as described hereinbelow.

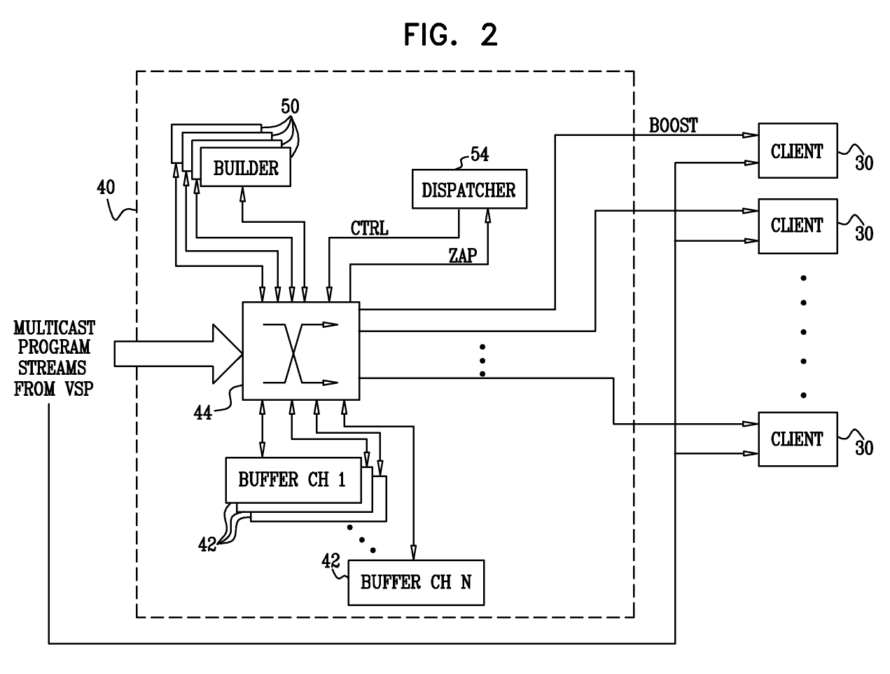

FIG. 2 is a block diagram that schematically shows details of a server 40, which supplies boost streams on request in accordance with an embodiment of the present invention. In practical implementations, such a server would typically be used in conjunction with hardware that provides network access multiplexing functions, such as in a Digital Subscriber Line Access Multiplexer (DSLAM). Various possible configurations for integration of the multicast and boost function, either as an external unit or as a part of the network equipment, will be apparent to those skilled in the art. For the sake of simplicity, FIG. 2 shows only the elements of server 40 that are involved in providing boost streams to decoders 30 of clients 28. The multicast streams are provided separately, as illustrated in the figure.

As shown in FIG. 2, the functions of server 40 are built around a switch 44, which receives packets belonging to multiple program streams from VSP 22 and sorts the packets by multicast channel. (The different channels are identified in the figure as CH 1, CH 2, . . . , CH N.) In this embodiment, for clarity of explanation, the streams are assumed to be MPEG-2 transport streams, but the principles of the present invention may similarly be applied to packetized media streams of other types, as noted above. The transport streams typically contain both video and accompanying audio data, along with signaling information, such as timing and program identity, as provided by the applicable standards.

Switch 44 directs each channel to a respective buffer 42, which comprises a memory for storing a recent set of one or more pictures transmitted over the channel. These pictures are used in generating a boost stream, as described hereinbelow, when a client asks to join the channel. The frames stored in buffer 42 typically include at least the most recent I-frame and may include one or more difference-coded frames, possibly including all of the frames in the stream starting from the most recent I-frame.

When one of the clients requests a new channel, server 40 passes a boost stream of the respective channel to the client. A builder 50 in the server generates and transmits the boost stream via switch 44 to the client, as described hereinbelow. The boost stream may comprise all the frames in a segment of the multicast stream, or certain selected frames.

When the boost stream reaches a point of synchronization with the multicast stream, i.e., a point at which the same frame is transmitted simultaneously in both the boost stream and the multicast stream, the server gives the client an indication of the synchronization point. At this point the client switches from the boost stream to the multicast stream. The switchover may be abrupt, i.e., the boost stream may terminate and the client may join the multicast stream immediately thereafter. Alternatively, there may be a period of overlap during which a final portion of the boost stream is transmitted simultaneously with the multicast stream. These different sorts of switchover techniques are described in greater detail hereinbelow.

Typically, builders 50 are assigned dynamically by a dispatcher 54 to serve specific channels depending on client requests. In this manner, a relatively small number of builders can serve a large number of clients. In some cases, a builder may serve two or more clients that have asked to join a particular channel within a certain time interval of one another, thus increasing the efficiency of use of builder resources. The operator of server 40 can choose to deploy an optimal number of builders by trading off cost against service. (If the operator deploys a small number of builders, and there is consequently no builder available when a given client submits a join request, dispatcher 54 will simply deny a boost stream, and the client will subsequently connect to the corresponding multicast stream without an intervening boost stream. The lack of an available builder will cause an increase in the channel switching latency, but no loss of service.) Alternatively, builders may be statically assigned to certain clients or groups of clients, or to certain multicast channels.

FIG. 2 shows the conceptual and functional structure of server 40, and does not necessarily reflect the actual hardware and/or software configuration of such apparatus, as will be apparent to those skilled in the art. The logical and switching functions of the server may be carried out by dedicated or programmable hardware, or by a general-purpose processor with appropriate software, or by a combination of hardware and software elements. The software may be downloaded to the server in electronic form, over a network, for example, or it may be provided on tangible media, such as optical, magnetic, or non-volatile electronic memory media.

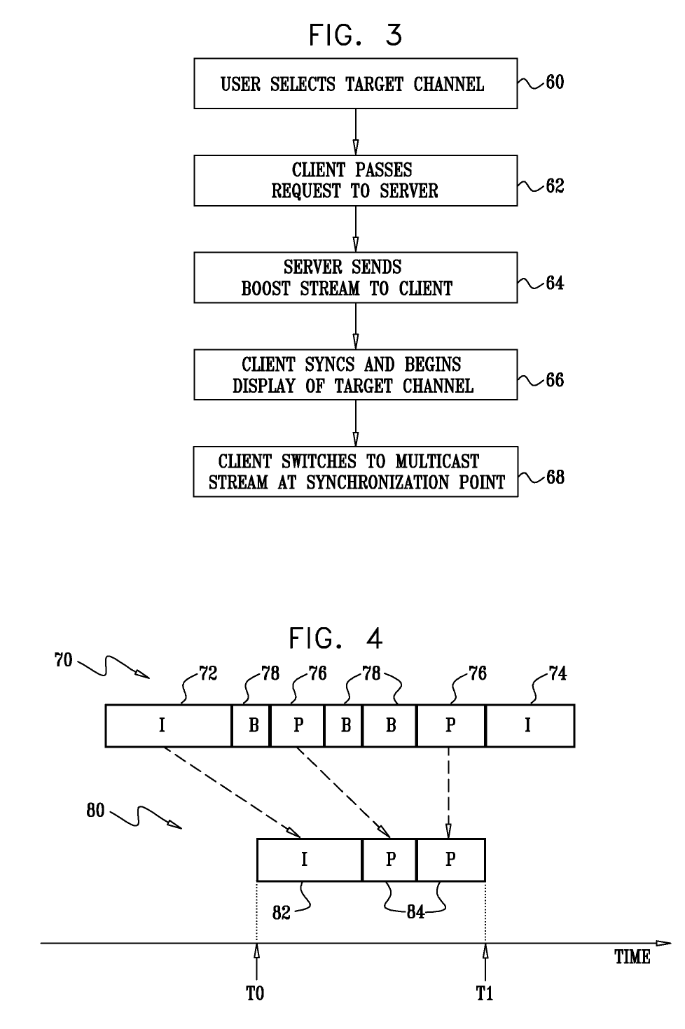

FIG. 3 is a flow chart that schematically illustrates a method for channel switching in system 20, in accordance with an embodiment of the present invention. The method is initiated when user 34 selects a new channel (referred to herein as the “target channel”), at a channel selection step 60. As noted above, in response to the user selection, the client sends a request for a boost stream to server 40 of the user's NSP, at a boost request step 62.

Switch 44 routes the request to dispatcher 54. In response to the request, the dispatcher chooses one of builders 50, and instructs the builder to generate a boost stream, based on the frames stored in memory 42 for that channel. A possible structure of the boost stream, with a reduced number of frames relative to the multicast stream, is described hereinbelow with reference to FIG. 4. Alternatively, the boost stream may comprise all of the frames that are included in the relevant portion of the multicast stream.

Builder 50 transmits the boost stream to the new client via switch 44, at a boost transmission step 64. Typically, the builder transmits the boost stream at an accelerated rate relative to the base rate of the multicast stream. (This base rate is specific to the multicast stream in question at the specific time at which the channel change takes place: The base rate is not necessarily constant, and may vary among the different multicast streams.) The difference in rates may be achieved by transmitting the boost stream at a higher bit rate than the base bit rate of the multicast stream. Additionally or alternatively, the acceleration may be achieved by other means, such as stronger compression of the boost stream than the multicast stream (so that the frame rate of the boost stream is increased relative to the multicast stream, even when both are transmitted at the same bit rate).

The boost stream typically begins with the most recent I-frame that has been stored in buffer 42, followed by one or more difference-coded frames. Typically, the boost stream also contains appropriate audio data from the multicast stream to accompany the video frames in the boost segment. Upon receiving the beginning I-frame in the boost stream, client immediately synchronizes on the target channel and begins to display pictures on television set 32, at a display initiation step 66. In the absence of this boost function, the delay until display of the new channel could be from one second to several seconds long, depending on the compression scheme that is used.

In some cases, if multiple clients submit requests to join the assigned channel during a given interval between two I-frames in the multicast stream, dispatcher 54 may instruct builder 50 to transmit multiple boost streams during this interval. If the client requests are received roughly simultaneously, the builder may transmit the same boost stream to multiple clients. Alternatively, the boost streams may start at different times. Alternatively, when multiple client requests for a boost stream of a given channel are received at staggered times during the interval between two I-frames, the dispatcher may assign multiple builders to transmit different boost streams for the same channel at staggered starting times.

Builder 50 may time each boost stream so that it will terminate at an anchor point (i.e., an I-frame) in the multicast stream of the target channel, but alternatively, the boost stream may (by virtue of its accelerated bit rate) reach the point of synchronization at a P- or B-frame or any other point in the MPEG stream, as well. Upon reaching the point of synchronization, the builder (or dispatcher 54 or decoder 30) instructs switch 44 to stop the boost stream or to reduce its bitrate to a fraction of the original bitrate. At this synchronization point the client will connect to the original multicast stream, at a client switching step 68. It is desirable that the transition from the boost stream to the multicast stream be smooth (and thus invisible to the user). For this purpose, the client stitches the boost stream data to the original multicast data so it is perceived by decoder 30 as one continuous MPEG stream.

There are a number of different ways in which the boost stream can be constructed in order to meet the criteria described above. For example, in one embodiment, the boost stream may simply be a delayed duplicate of the original multicast transport stream, which builder 50 transmits to decoder 30 at an accelerated bit rate relative to the base bit rate required for the multicast stream. Some of the frames at the end of the duplicate stream may be eliminated if necessary so that the boost stream terminates at an appropriate time.

FIG. 4 is a timing diagram that schematically illustrates construction and transmission of a boost stream 80 based on a portion 70 of a multicast stream, in accordance with another embodiment of the present invention. The multicast stream comprises an I-frame 72, followed by B-frames 78 and P-frames 76, then followed by another I-frame 74. The P-frames encode differences with respect to the preceding I- or P-frame, while the B-frames encode differences with respect to both preceding and succeeding frames. This method of constructing the multicast stream may be used in the boost stream as well, in conjunction with accelerated-rate transmission. Alternatively, as noted above, builder 50 may create the boost stream simply by transmitting the original multicast stream at an accelerated rate.

Builder 50 begins transmission of boost stream 80 at a time T0, which is determined by the time at which the builder receives the request for a boost stream submitted by the client (or clients) to whom the boost stream is to be directed. The builder begins the boost stream with an I-frame 82, which is identical to or derived from I-frame 72. I-frame 82 is followed by P-frames 84, which are identical to or derived from P-frames 76. B-frames 78 may be removed. In the example shown in FIG. 4, the boost stream is constructed so that the point of synchronization, Ti, corresponds to a P-frame that immediately precedes the next I-frame 74 in the multicast stream. Alternatively, the point of synchronization may occur at any other suitable point in the multicast stream.

There are a number of ways in which boost stream 80 may be terminated at the point of synchronization, when the client joins the multicast stream:
In one embodiment, builder 50 stops transmitting the boost stream abruptly at the point of synchronization.
In another embodiment, builder 50 stops transmitting the boost stream abruptly at the point of synchronization, and decoder 30 receives an indication that it is time to switch over to the multicast stream. The “indication,” for this purpose, may comprise a predetermined signal that the builder sends to the decoder, or it may simply be the termination of the boost stream itself. Upon receiving this indication, the client joins the respective multicast stream. If there is a time gap between the end of the boost stream and the initial multicast frame that the client receives, the client may request additional frames from the builder in order to fill the gap.
In an alternative embodiment, when builder 50 reaches the point of synchronization in the boost stream, it indicates this point to decoder 30 and meanwhile continues transmitting the boost stream, but now at a reduced bit rate (for example, 20% of the base bit rate). The indication in this case can be simply the reduction of the bitrate to the reduced bitrate. In response to the signal from the builder, the client joins the corresponding multicast stream, so that for a certain overlap period, the client receives both boost and multicast streams simultaneously. When the client recognizes that it has received identical frames in the boost and multicast streams, it begins displaying the multicast frames and signals the builder to stop transmitting the boost stream

In all of the above scenarios, the decoder is able to make a seamless transition (from the user's point of view) from the boost stream to the multicast stream. The last alternative, in which the boost and multicast streams are transmitted simultaneously, may be advantageous in avoiding buffer underflow; but even in the other options, transmission of the boost stream at the accelerated bit rate means that the decoder buffer (not shown) will contain a certain reserve of video data at the point of synchronization, so that underflow can generally be avoided. The client may make the transition from displaying the boost stream to displaying the multicast stream based on the respective timestamps, or it may alternatively apply pattern recognition to the video data in the frames of the boost and multicast streams near the synchronization point in order to stitch the data together and make the transition at that point.

In order to shorten the boost stream, builder 42 may eliminate the B-frames and some or all of the P-frames in the boost stream. Since each P-frame requires the preceding P- or I-frame for decoding, the builder removes the P-frames starting from the end of the boost stream (i.e., it would remove the second P-frame 82 in FIG. 5). Removal of the B-frames has no effect on P-frame decoding.

When the video content of boost stream 80 differs from portion 70 of the multicast stream, the transport stream that was used to encapsulate portion 70 should not be used to encapsulate the boost stream without making certain changes. The above-mentioned U.S. patent application Ser. No. 11/321,290 describes methods for constructing the transport stream in such cases.

Additionally or alternatively, builder 42 may apply stronger compression to the frames in the boost stream than is applied to the corresponding frames in the multicast stream. For example, the builder may reduce the number of discrete cosine transform (DCT) coefficients that are used in encoding each of the frames. This compression is lossy, so that user 34 will, as a result, see pictures of reduced quality during the boost phase. On the other hand, increasing the compression of the individual frames may permit builder 42 to transmit a larger number of frames in the boost stream, so that the transition to the multicast stream is smoother, and the picture on television set 32 does not visibly “jump” during or at the end of the boost phase.

As noted earlier, although the embodiments described hereinabove refer specifically to MPEG standards and use MPEG terminology, the principles of the present invention may similarly be applied in digital broadcast systems using other compression and packet transport schemes. For example, the methods and systems described above may be adapted to operate with MPEG-4 part 10 streams (also known as H.264 or Advanced Video Codec), as well as with the SMPTE VC-1 video codec (contributed by Microsoft).

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for digital video distribution in which a program is transmitted over a network as a multicast stream at a base rate, the stream including a sequence of frames encoding video data, the sequence containing anchor points, the method comprising:
receiving, at a time subsequent to a given anchor point in the multicast stream, a request from a client to begin receiving the program; and
responsively to the request, transmitting to the client a boost stream beginning from the given anchor point at an accelerated rate relative to the base rate, the boost stream comprising at least a portion of the video data in the multicast stream, so as to cause the client to display the video data beginning from the given anchor point based on the boost stream and then to join the multicast stream when the boost stream has reached a point of synchronization with the multicast stream.

2. The method according to claim 1, wherein the given anchor point is a first anchor point, and wherein the point of synchronization is a second anchor point in the multicast stream, subsequent to the first anchor point.

3. The method according to claim 1, wherein transmitting the boost stream comprises terminating the boost stream at the point of synchronization.

4. The method according to claim 1, wherein transmitting the boost stream comprises continuing to transmit the boost stream to the client at a reduced rate relative to the base rate for a period of time following the point of synchronization, simultaneously with reception of the multicast stream by the client.

5. The method according to claim 1, wherein transmitting the boost stream comprises conveying an indication of the point of synchronization to the client, which causes the client to switch over to the multicast stream.

6. The method according to claim 1, wherein the sequence of frames comprises intracoded frames (I-frames) interspersed with difference-coded frames, and wherein each of the anchor points corresponds to one of the I-frames.

7. The method according to claim 1, wherein the multicast stream is one of multiple channels of video content, which are transmitted to multiple clients, and wherein receiving the request comprises receiving the request from a user viewing a first channel to switch to a second channel.

8. Communication apparatus, for operation in conjunction with transmission of a program as a multicast stream over a network at a base rate, the stream including a sequence of frames encoding video data, the sequence containing anchor points, the apparatus comprising:
a memory, which is coupled to store the video data; and
boost generation logic, which is coupled to the memory and is arranged to receive, at a time subsequent to a given anchor point in the multicast stream, a request from a client to begin receiving the program, and to transmit to the client, responsively to the request, a boost stream beginning from the given anchor point at an accelerated rate relative to the base rate, the boost stream comprising at least a portion of the video data in the multicast stream, so as to cause the client to display the video data beginning from the given anchor point based on the boost stream, and to cause the client to join the multicast stream when the boost stream reaches a point of synchronization with the multicast stream.

9. The apparatus according to claim 8, wherein the given anchor point is a first anchor point, and wherein the point of synchronization is a second anchor point in the multicast stream, subsequent to the first anchor point.

10. The apparatus according to claim 8, wherein the boost generation logic is configured to terminate the boost stream at the point of synchronization.

11. The apparatus according to claim 8, wherein the boost generation logic is configured to transmit the boost stream to the client at a reduced rate relative to the base rate for a period of time following the point of synchronization, simultaneously with reception of the multicast stream by the client.

12. The apparatus according to claim 8, wherein the boost generation logic is configured to convey an indication of the point of synchronization to the client so as to cause the client to send a request to join the multicast stream at the point of synchronization.

13. The apparatus according to claim 8, wherein the sequence of frames comprises intracoded frames (I-frames) interspersed with difference-coded frames, and wherein each of the anchor points corresponds to one of the I-frames.

14. The apparatus according to claim 8, wherein the multicast stream is one of multiple channels of video content, which are transmitted to multiple clients, and wherein the request comprises an instruction from the user who is viewing a first channel to switch to a second channel.

15. The transmitter according to claim 14, wherein the boost generation logic comprises a plurality of builders, which are dynamically assignable to produce boost streams for the multiple channels responsively to boost stream requests from the clients.

16. A computer software product, for use in conjunction with a multicast transmitter, which transmits a program as a multicast stream over a network at a base rate, the stream including a sequence of frames encoding video data, the sequence containing anchor points, the product comprising a computer-readable medium in which program instructions are stored,
wherein the instructions, when read by a computer associated with the transmitter, cause the computer to receive, at a time subsequent to a given anchor point in the multicast stream, a request from a client to begin receiving the program, and to transmit to the client, responsively to the request, a boost stream beginning from the given anchor point at an accelerated rate relative to the base rate, the boost stream comprising at least a portion of the video data in the multicast stream, so as to cause the client to display the video data beginning from the given anchor point based on the boost stream, and to cause the client to join the multicast stream when the boost stream has reached a point of synchronization with the multicast stream.

17. The product according to claim 16, wherein the given anchor point is a first anchor point, and wherein the point of synchronization is a second anchor point in the multicast stream, subsequent to the first anchor point.

18. The product according to claim 16, wherein the instructions cause the computer to terminate the boost stream at the point of synchronization.

19. The product according to claim 16, wherein the instructions cause the computer to transmit the boost stream to the client at a reduced rate relative to the base rate simultaneously with reception of the multicast stream by the client for a period of time following the point of synchronization.

20. The product according to claim 16, wherein the instructions cause the computer to cause the client to send a request to join the multicast stream at the point of synchronization.

21. A method for digital video distribution in which a program is transmitted as a multicast stream over a network at a base rate, the stream including a sequence of frames encoding video data, the sequence containing anchor points, the method comprising:
transmitting, at a time subsequent to a given anchor point in the multicast stream, a request from a client to begin receiving the program; and
responsively to the request, receiving at the client a boost stream beginning from the given anchor point at an accelerated rate relative to the base rate, the boost stream comprising at least a portion of the video data in the multicast stream;
receiving at the client an indication that the boost stream has reached a point of synchronization with the multicast stream;
responsively to the indication, joining the client to the multicast stream; and
displaying the video data at the client beginning from the given anchor point based initially on the boost stream and then subsequently on the multicast stream.
